(19) United States
(12) Patent Application Publication
(10) Pub. No.: US 2012/0282862 A1
(43) Pub. Date: Nov. 8, 2012

(54) USER EQUIPMENT ENERGY REPORTING FOR ENABLING POWER EFFICIENT OPERATIONS OF NETWORKS

(76) Inventors: Jeroen Wigard, Klarup (DK); Frank Frederiksen, Klarup (DK); Troels Emil Kolding, Klarup (DK); Lars Dalsgaard, Oulu (FI)

(21) Appl. No.: 13/516,808

(22) PCT Filed: Dec. 18, 2009
(86) PCT No.: PCT/US09/68850

§ 371 Date: Jul. 16, 2012

(51) Int. Cl. H04B 17/00; H04W 88/02

(52) U.S. Cl. 455/67.11

(57) ABSTRACT

Methods and apparatus, including computer program products, are provided for enabling power efficient operation. In one aspect, there is provided a method including receiving a request for an indication of a value representative of an energy consumption of at least one of a transmission and a reception at a user equipment. Moreover, the value is determined in response to the request. The value may also be determined for one of a plurality of radio access technologies provided by the user equipment. The determined value may be reported to a network element. Related apparatus, systems, methods, and articles are also described.

### FIELD

The subject matter described herein relates to wireless communications.

### BACKGROUND

Mobile phones and other user equipment have become ubiquitous. However, unlike traditional forms of communication, such as a letter written on paper and pencil, mobile phones essentially require a continuous source of power. Moreover, as the capabilities of these mobile devices increases, there will be an increased need to efficiently use power and maintain a so-called “green” profile.

### SUMMARY

Methods and apparatus, including computer program products, are provided for enabling power efficient operation. In one aspect, there is provided a method including receiving a request for an indication of a value representative of an energy consumption of at least one of a transmission and a reception at a user equipment. Moreover, the value is determined in response to the request. The value may also be determined for one of a plurality of radio access technologies provided by the user equipment. The determined value may be reported to a network element.

In another aspect there is provided a method. The method may include sending a request for a value representative of an energy consumption of at least one of a transmission and a reception at a user equipment; and receiving, in response to the request, the value representative the energy consumption for one of a plurality of radio access technologies available at the user equipment.

In another aspect, there may be provided a method. The method may include sending, by a network element, a request for an indication of a value representative of an energy consumption; receiving, at a user equipment, the request; determining the value representative of the energy consumption at the user equipment during at least one of a transmission and a reception; and reporting the determined value to the network element.

The above-noted aspects and features may be implemented in systems, apparatus, methods, and/or articles depending on the desired configuration. The details of one or more variations of the subject matter described herein are set forth in the accompanying drawings and the description below. Features and advantages of the subject matter described herein will be apparent from the description and drawings, and from the claims.

### DESCRIPTION OF DRAWINGS

In the drawings,

FIG. 1 depicts a block diagram of a wireless communication system;

FIG. 2 depicts a process for monitoring and reporting energy consumption;

FIG. 3 depicts an example of a user equipment; and

FIG. 4 depicts an example of a base station.

Like labels are used to refer to same or similar items in the drawings.

### DETAILED DESCRIPTION

The subject matter described herein relates to monitoring and reporting energy consumption for one or more radio access technologies being used by a user element (also referred to as user equipment) and selecting the radio access technology based on the reported energy consumption information.

In the past, a number of network technologies have been standardized. These radio access technologies include Global System for Mobile communications (GSM), Universal Mobile Telecommunications System (UMTS), Long Term Evolution (LTE), and the like. Typically, user equipment, such as a mobile phone, is configured to operate with a plurality of radio access technologies. Indeed, as user equipment continues to evolve, it is anticipated that a given user equipment (UE) may be able to support not only GSM, UMTS, and LTE radio access technologies, but also radio access technologies such as LTE-Advanced, wireless local area networks (WLAN), WiMAX, Bluetooth, and the like.

One typical feature of each radio access technology is that as new techniques are developed, the supported data rates increase, but on the other hand, power consumption of the user equipment also increases. For example, a given mobile phone may be able to connect to networks using radio access technologies, such as GSM, Wideband Code Division Multiple Access (WCDMA), High-Speed Downlink Packet Access (HSDPA), Unlicensed Mobile Access (UMA), and WLAN. In this example, using WLAN may drain the mobile phone more quickly than the other radio access technologies. On the other hand, the same phone controlled to operate only in GSM mode as the radio access technology will drain the least power, when compared to these other radio access technologies—having thus a higher stand-by time. In short, depending on which radio access technology is used, the power consumption of the user equipment and thus the corresponding standby time will vary accordingly.

Moreover, in some implementations, the user equipment may operate over multiple radio access technologies simultaneously by monitoring, for example, GSM, UTRAN, E-UTRAN, UMA, Bluetooth, and other connections (e.g., the user equipment continuously measures the different radio access technologies in order to be connected to an optimum network at any given time). As such, the energy consumption typically increases with the number of radio access networks supported by the user equipment and the higher data rates/bandwidth of these networks. The subject matter described herein thus provides for monitoring and reporting the cost in power related to a transmission from and/or reception by a user equipment supporting one or more radio access technologies. For example, the monitoring may determine what the cost is, in terms of energy consumption (e.g., power per transmitted and/or received bit for one or more radio access technologies available at the user equipment). This monitored cost information may be used to optimize the power consumption in at least one of the user equipment, a base station, and other nodes of the network.

As described above, it has been observed that user equipment will have different energy consumption when configured to use different radio access technologies. In an ideal world, the energy consumption for each radio access technology would scale linearly with the potential, offered data rate. However, given that different systems are designed differently (e.g., with different sleep/wake modes, power conservation and probing mechanisms, etc.), power consumption by the user equipment does not necessarily scale linearly with data rate. Thus, monitoring may be used to determine the actual power consumed by a user equipment when using each of the radio access technologies available at the user equipment.

Before providing additional implementation examples for monitoring and reporting the energy consumption by user equipment (e.g., cost in power related to a transmission from and/or reception by a user equipment supporting a plurality of different, radio access technologies), the following provides an example network in which the subject matter described herein may be implemented.

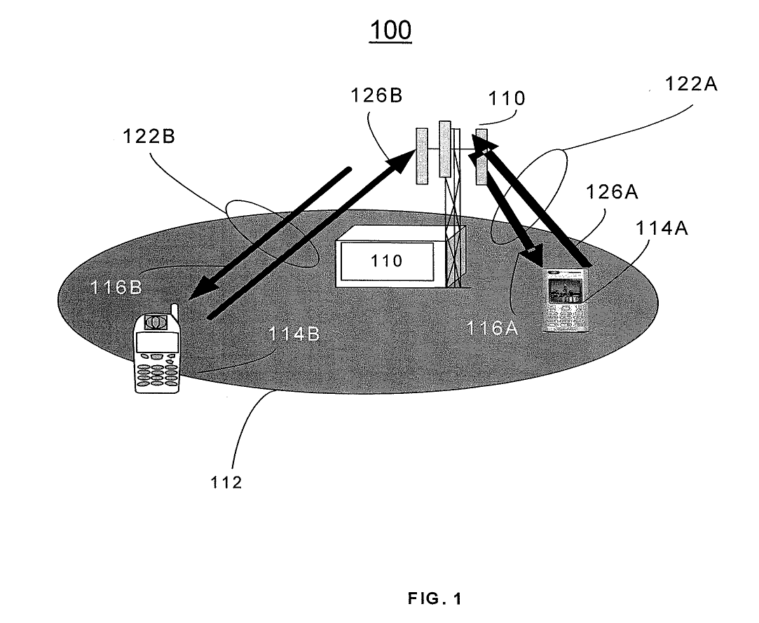

FIG. 1 is a simplified functional block diagram of a wireless communication system 100. The wireless communication system 100 includes a base station 110 supporting a corresponding service or coverage area 112 (also referred to as a cell). The base station 110 is also capable of communicating with wireless devices, such as user equipment 114A-B, within the coverage area. Although FIG. 1 depicts a single base station 110, a single coverage area 112, and two user equipment 114A-B, other quantities of base stations, coverage areas (including local wireless local area networks), and user equipment may be implemented as well.

In some implementations, base station 110 is implemented as an evolved Node B (eNB) type base station consistent with standards, including the Long Term Evolution (LTE) standards, such as 3GPP TS 36.201, “Evolved Universal Terrestrial Radio Access (E-UTRA); Long Term Evolution (LTE) physical layer; General description,” 3GPP TS 36.211, “Evolved Universal Terrestrial Radio Access (E-UTRA); Physical channels and modulation,” 3GPP TS 36.212, “Evolved Universal Terrestrial Radio Access (E-UTRA); Multiplexing and channel coding,” 3GPP TS 36.213, “Evolved Universal Terrestrial Radio Access (E-UTRA); Physical layer procedures,” 3GPP TS 36.214, “Evolved Universal Terrestrial Radio Access (E-UTRA); Physical layer—Measurements,” and any subsequent additions or revisions to these and other 3GPP series of standards (collectively referred to as LTE standards). The base station 110 may also be implemented consistently with the Institute of Electrical and Electronic Engineers (IEEE) Standard for Local and metropolitan area networks, Part 16: Air Interface for Fixed Broadband Wireless Access Systems, 1 Oct. 2004, IEEE Standard for Local and metropolitan area networks, Part 16: Air Interface for Fixed and Mobile Broadband Wireless Access Systems, 26 Feb. 2006, IEEE 802.16m, Advanced Air Interface, and any subsequent additions or revisions to the IEEE 802.16 series of standards (collectively referred to as IEEE 802.16).

In some implementations, the wireless communication system 100 may include access links 122A-B between the base station 110 and the user equipment 114A-B. The wireless communication system 100 may also include local wireless network access point, such as a WiFi access device, to allow the user equipment to access communication system 100 and/or eNB 110. In some implementations, the local wireless network access point is implemented in accordance with UMA. The access links 122A-B may also include a downlink, such as downlinks 116A-B, and the like, for transmitting from the base station 110 to a corresponding user equipment, such as user equipment 114A-B. The access links 122A-B also include an uplink, such as uplinks 126A-B and the like, for transmitting from the user equipment 114A-B to the base station 110.

Although the base station 110 is described as an eNB type base station, the base station 110 may be configured in other ways as well and include (or integrated with), for example, cellular base station transceiver subsystems, gateways, local wireless access points (e.g., a WiFi and/or a UMA access point), radio frequency (RF) repeaters, frame repeaters, nodes, and include access to other networks as well. For example, base station 110 may have wired and/or wireless backhaul links to other network elements, such as other base stations, a radio network controller, a core network, a serving gateway, a mobility management entity, a serving GPRS (general packet radio service) support node, and the like.

The user equipment 114A-B may be implemented as a mobile device and/or a stationary device. In any case, the user equipment 114A-B may include a plurality of radio access technologies to access communication system 100. The user equipment is often referred to as, for example, mobile stations, mobile units, subscriber stations, wireless terminals, or the like. The user equipment may be implemented as, for example, a wireless handheld device, a wireless plug-in accessory, or the like. In some cases, the user equipment may include one or more of the following: at least one processor, at least one computer-readable storage medium (e.g., memory, storage, and the like), one or more radio access mechanisms, and a user interface. For example, the user equipment may take the form of a wireless telephone, a computer with a wireless connection to a network, or the like.

In some implementations, the links 116A-B and 126A-B each represent a radio frequency (RF) signal. The RF signal may include data, such as voice, video, images, Internet Protocol (IP) packets, control information, and any other type of information. When IEEE-802.16 and/or LTE are used, the RF signal may use OFDMA. OFDMA is a multi-user version of orthogonal frequency division multiplexing (OFDM). In OFDMA, multiple access is achieved by assigning, to individual users, groups of subcarriers (also referred to as subchannels or tones). The subcarriers are modulated using BPSK (binary phase shift keying), QPSK (quadrature phase shift keying), or QAM (quadrature amplitude modulation), and carry symbols (also referred to as OFDMA symbols) including data coded using a forward error-correction code.

As noted above, in some implementations, the user equipment may be implemented to operate using one or more of a plurality of radio access technologies. For example, the links to and/or from the user equipment may be configured to comply substantially with a standard system specification, such as LTE or other wireless standards, such as WiBro, WiFi, Bluetooth, IEEE 802.16, GSM, LTE, LTE-Advanced, UMA, WiLAN, Bluetooth, or it may be a proprietary system.

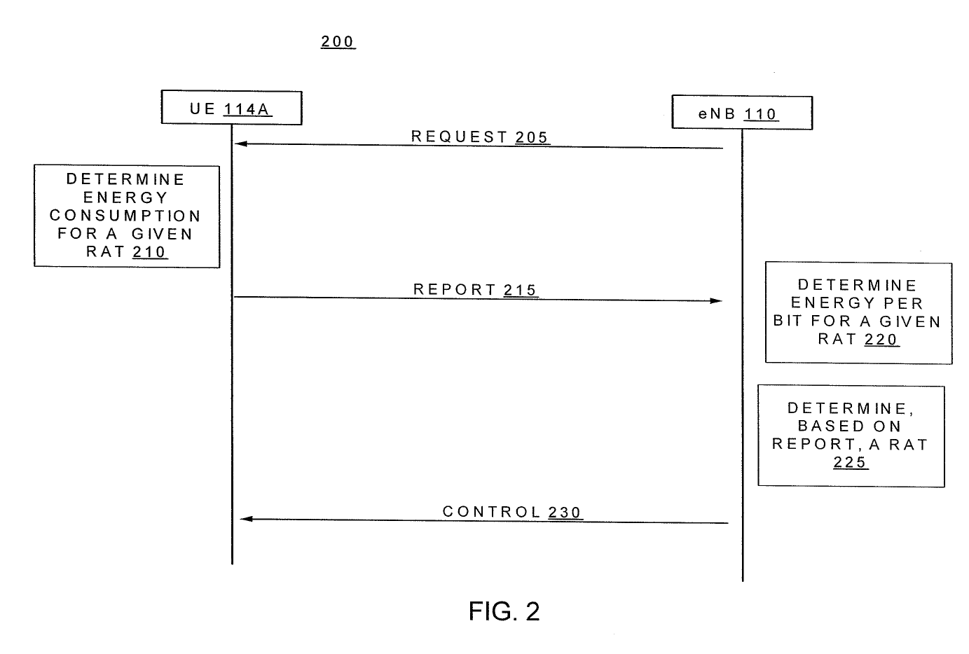

FIG. 2 depicts a process 200 for monitoring and reporting the cost of a given radio access technology. In some implementations, the cost is expressed as power consumption by the user equipment when operating in a given radio access technology available at the user equipment.

FIG. 2 depicts user equipment 114A and eNB 110, although any other user equipment, base stations, and/or network nodes may be implemented using process 200 as well.

At 205, a network node, such as eNB 110, may send a request message to the user equipment 114A. The request message indicates to the user equipment 114A to report its energy consumption under the current radio access technology being used by the user equipment 114A to communicate (i.e., at least one of transmit or receive) For example, a radio resource control message may be used to carry the request message at 205, although other mechanisms may be used as well. For example, rather than using control the control plane signaling of radio resource control, user plane messages may be used as well to carry the request message 205. For example, an application running in the UE, which registers with a network application at the eNB, received the request message at 205.

At 210, the user equipment determines energy consumption for a radio access technology being used to communicate. For example, the user equipment 114A may include both GSM and WiFi radio access technologies, and communicate with the eNB 110 via a local WiFi/unlicensed mobile access (UMA) connection. When this is the case, the user equipment 114A may determine its energy consumption. In some implementations, the user equipment 114A may determine the energy consumption of the radio access technology being used in terms of energy per bit for that given radio access technology. Returning to the previous example, the user equipment 114A may determine what the energy per bit transmitted via the local WiFi/unlicensed mobile access (UMA) uplink connection to eNB 110 and/or the energy consumption for receiving one or more bits at the user equipment 114A. The user equipment 114A can typically determine (e.g., via measurement, monitoring, etc.) the transmitted power per bit. For example, internally the user equipment may track the amount of information (or, e.g., all bits) transmitted and/or received and compare that with the power (e.g., by measuring power, voltage, and/or current) used for that transmission and/or reception. Moreover, the determined power may be averaged, although in some implementations averaging may not be used. If the user equipment 114A in the previous example switches to GSM, the user equipment 114A may then determine its energy consumption in GSM mode. For example, user equipment 114A may determine the energy per bit for bits transmitted to (and/or received from) the eNB 110 using GSM.

Moreover, in some implementations, the energy per bit measurement may be averaged over a given period of time.

Although the above examples refers to determining energy consumption of information transmitted by the user equipment 114A to eNB 110, the downlink information, such as bits transmitted from the eNB or other network element to the user equipment 114A, may also be determined. For example, the user equipment 114A may measure the downlink power and determine the energy per bit given the measured power, although the power and energy per bit may be measured by other network elements as well (e.g., the eNB 110).

In some implementations, the power consumption of the radio section of the user equipment (e.g., the radio section comprising receive and/or transmit components) is monitored as well. For example, the power consumption of the radio section (which includes the radio frequency portion of the user equipment), may be estimated based on a combination of one or more of the following: the amount of time the radio section is active, the activity level, and whether the radio section is receiving or transmitting when active (and when transmitting the transmit power level).

At 215, the user equipment 114A reports to the network, such as eNB 110, the energy consumption determined in 210. Returning to the previous example, when the user equipment 114A determines the energy consumption in terms of energy per transmitted bit in 210, the energy consumption information is reported to the eNB 110 in a message, such as a radio resource control message at 215, although user plane messages may be used as well to carry the report message 215.

In some implementations, at 220, the network, such as eNB 110, may also determine energy consumption. For example, the eNB 110 may determine the energy consumption of the downlink to the user equipment 114A based on the power transmitted by the eNB 110 to the user equipment for a given radio access technology. For example, when the eNB 110 is transmitting via a GSM downlink to user equipment 114A, the eNB 110 may determine the power consumption (e.g., energy per bit of power transmitted via the downlink to the user equipment 114A), and also determine power consumption when operating via WiFi/UMA (e.g., energy per bit of power transmitted via the link to user equipment 114A).

At 225, the network may determine which radio access technology is more energy efficient for a given user equipment. For example, eNB 110 may determine, based on the report 215 as well as other information available to the network that for user equipment 114A, that WiFi/UMA is a more energy efficient in terms of power consumption (e.g., energy per bit). When this is the case, the eNB 110 may provide, at 230, a message to user equipment 114A to control operation so that user equipment 114A is in a WiFi/UMA mode. The control message at 225 may be carried in a handover command, a radio resource control connection reconfiguration message, and/or any other type of message. Moreover, the network 100 including eNB 110 may evaluate over time which radio access technology would be the most energy efficient for the user equipment 114A operation given the needed, supported data rate as defined in, for example, a quality of service (QoS) profile for the user equipment.

The process 200 may be repeated, such that at any given time the eNB 110 may determine that another radio access technology, such as GSM, is more energy efficient in terms of power consumption. When this is the case, the eNB 110 may provide, at 230, a message to user equipment 114A to control operation so that user equipment 114A is in a GSM mode.

Although process 200 was described with respect to GSM, WiFi, and UMA, other radio access technologies may be included in process 200 to allow a selection of a radio access technology that is relatively more efficient (e.g., in terms of energy per bit transmitted/received) than other radio access technologies at a given user equipment at a given period of time.

In some implementations, the user equipment reports the energy consumption for the user equipment radio section (e.g., radio modem) rather than other components of the user equipment. In implementations in which the user equipment reports the energy consumption for the user equipment radio section only, energy consumption caused by a higher-layer application (e.g., a browser application presenting a video/audio clip on a display) is somewhat decoupled from the radio access technology energy consumption. Moreover, in some implementations, the user equipment separately reports at 215 power consumption for uplink operation and downlink operation, although a single report may be used for both the uplink and downlink as well. This separate reporting for the uplink and the downlink may allow the network (e.g., eNB 110) to know the radio performance when evaluating the overall performance.

In some implementations, report 215 includes information indicative of whether the user equipment 114A is operating while connected to an external power supply or whether it is operating in battery mode. In the latter case, the subject matter described herein may provide enhanced energy efficient operation of the user equipment 114A.

In some implementations, the process 200 may provide one or more advantages including, for example, operation of the user equipment, such as a mobile phone, in an energy efficient—and thus “green”—operation. Moreover, if a service provider's network 100 supports process 200, the network 100 as a whole operates in an energy efficient manner, allowing for “green” wireless networks.

In another aspect, the reports at 215 may also be used for parameter optimization in the eNB 110. With such a scheme, the eNB 110 may track the consumed power as a function of different settings for different profiles, such as quality of service (QoS), QoS class indicator, and the like. By monitoring and recording over time the consumed power, the network 100 is able to identify parameter settings providing efficient energy consumption for a given type a traffic, such as hyper text mark-up language (HTML) traffic, voice over internet protocol (VoIP) traffic, and the like. Having such information in the eNB 110 and in an automated way (e.g., as in a self-optimizing network (SON)) may also help in assuring use of optimal and optimized power saving settings in a service provider's public land mobile network.

In some implementations, report 215 may include additional information regarding power consumption. For example, the user equipment 114A may provide information via report 215 on power consumption when in idle mode. When this is the case, energy consumption for idle modes is compared. As such, the report 215 allows the eNB 110 to determine which radio access technology is energy efficient for idle mode operation at user equipment 114A. Although specific examples of energy consumption metrics are provided above (e.g., energy per bit), any metric may be used that represents the amount of power used over a given period of time.

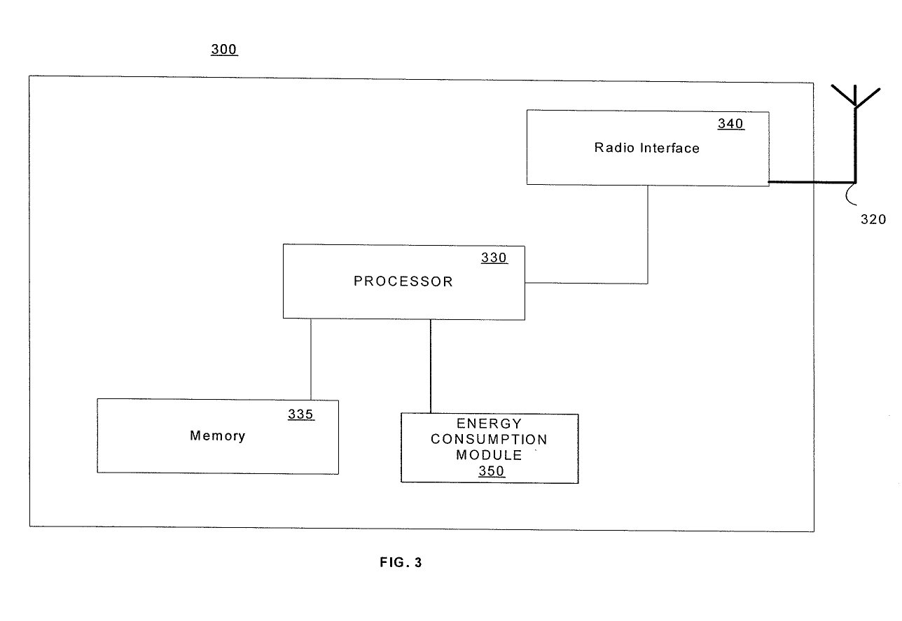

FIG. 3 depicts an exemplary user equipment 300, which may be implemented at one or more of user equipment 114A-B. The user equipment may include an antenna 320. The user equipment may also includes a radio interface 340, which may include other components, such as filters, converters (e.g., digital-to-analog converters and the like), symbol demappers, an Inverse Fast Fourier Transform (IFFT) module, and the like, to process symbols, such as OFDMA symbols, carried by a downlink or an uplink. In some implementations, the user equipment may also be compatible with IEEE 802.16, WiMax, Bluetooth, WiFi, GSM, UMA, LTE, LTE-Advanced, and the like. The user equipment may further include a processor 330 for controlling the user equipment and for accessing and executing program code stored in memory 335.

Furthermore, the user equipment may include an energy consumption module 350. The energy consumption module 350 may be configured to perform one or more of the aspects noted with respect to processes 200. For example, the energy consumption module 350 may receive the request to monitor and/or report energy consumption, determine energy consumption for the user equipment, send the report to the network, such as the eNB, and switch between operating modes based on for example the control message 230.

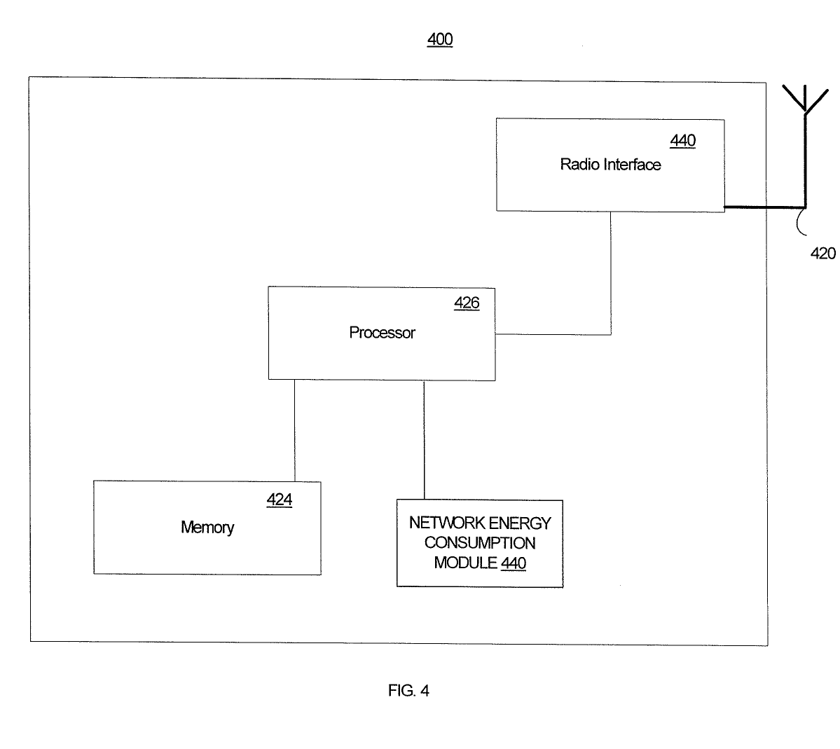

FIG. 4 depicts an example implementation of a base station 400, which may be implemented at base station 110. The base station may include an antenna 420 configured to transmit via a downlink and configured to receive uplinks via the antenna(s) 420. The base station may further include a radio interface 440 coupled to the antenna 420, a processor 426 for controlling the base station and for accessing and executing program code stored in memory 424. The radio interface 440 further includes other components, such as filters, converters (e.g., digital-to-analog converters and the like), mappers, a Fast Fourier Transform (FFT) module, and the like, to generate symbols for a transmission via one or more downlinks and to receive symbols (e.g., via an uplink). In some implementations, the base station is also compatible with IEEE 802.16, LTE, LTE-Advanced, UMA, and the like, and the RF signals of downlinks and uplinks may be configured as an OFDMA signal, or other type of waveform as well.

The base station 400 may further include a network energy consumption module 440. The network energy consumption module 440 may be configured to perform one or more of the aspects noted with respect to processes 200. For example, the energy consumption module 440 may send the request to monitor and/or to report energy consumption (e.g., request 205), determine energy consumption, receive energy consumption from a plurality of user equipment, determine a radio access technology based on the reported energy consumption, and send a message to control the user equipment to operate in a radio access technology (e.g., control 230) based on the energy consumption reports as well as other information available to the base station.

The subject matter described herein may be embodied in systems, apparatus, methods, and/or articles depending on the desired configuration. For example, the base stations and user equipment (or one or more components therein) and/or the processes described herein can be implemented using one or more of the following: a processor executing program code, an application-specific integrated circuit (ASIC), a digital signal processor (DSP), an embedded processor, a field programmable gate array (FPGA), and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. These computer programs (also known as programs, software, software applications, applications, components, program code, or code) include machine instructions for a programmable processor, and may be implemented in a high-level procedural and/or object-oriented programming language, and/or in assembly/machine language. As used herein, the term “machine-readable medium” refers to any computer program product, computer-readable medium, apparatus and/or device (e.g., magnetic discs, optical disks, memory, Programmable Logic Devices (PLDs)) used to provide machine instructions and/or data to a programmable processor, including a machine-readable medium that receives machine instructions. Similarly, systems are also described herein that may include a processor and a memory coupled to the processor. The memory may include one or more programs that cause the processor to perform one or more of the operations described herein.

Although a few variations have been described in detail above, other modifications or additions are possible. In particular, further features and/or variations may be provided in addition to those set forth herein. For example, the implementations described above may be directed to various combinations and subcombinations of the disclosed features and/or combinations and subcombinations of several further features disclosed above. In addition, the logic flow depicted in the accompanying figures and/or described herein does not require the particular order shown, or sequential order, to achieve desirable results. Other embodiments may be within the scope of the following claims.

What is claimed:

1. A method comprising:
receiving a request for an indication of a value representative of an energy consumption of at least one of a transmission and a reception at a user equipment;
determining, in response to the request, the value representative of the energy consumption, the value determined for one of a plurality of radio access technologies provided by the user equipment; and
reporting the determined value to a network element.

2. The method of claim 1 further comprising:
operating using at least one of the plurality of radio access technologies based on the energy consumption.

3. The method of claim 1 further comprising:
switching, based on a control message sent by a network element to the user equipment, to one of the plurality of radio access technologies, the control message determined based on the reported determined value representative of the energy consumption.

4. The method of claim 1, wherein the determining further comprises:
determining the energy consumption during the transmission of one or more bits transmitted by the user equipment.

5. The method of claim 1, wherein the determining further comprises:
determining the energy consumption during the reception of one or more bits received by the user equipment.

6. The method of claim 1, wherein the determining further comprises:
determining the energy consumption of the user equipment when operating in at least one of an idle mode and a connected mode of one or more of the plurality of radio access technologies.

7. A method comprising:
sending a request for a value representative of an energy consumption of at least one of a transmission and a reception at a user equipment; and
receiving, in response to the request, the value representative the energy consumption for one of a plurality of radio access technologies available at the user equipment.

8. The method of claim 7, wherein the value represents the energy consumption associated with at least one of the transmission and the reception of one or more bits using at least one of the plurality of radio access technologies.

9. The method of claim 7, wherein the value represents the energy consumption associated with at least one of an idle mode and a connected mode of at least one of the plurality of radio access technologies.

10. The method of claim 7 further comprising:
sending an indication to control operation between the plurality of radio access technologies based on the reported determined value.

11. An apparatus comprising:
at least one processor; and
a memory configured to provide operations comprising:
receiving a request for an indication of a value representative of an energy consumption of at least one of a transmission and a reception at a user equipment;
determining, in response to the request, the value representative of the energy consumption, the value determined for one of a plurality of radio access technologies provided by the user equipment; and
reporting the determined value to a network element.

12. The apparatus of claim 11 further comprising:
operating using at least one of the plurality of radio access technologies based on the energy consumption.

13. The apparatus of claim 11 further comprising:
switching, based on a control message sent by a network element to the user equipment, to one of the plurality of radio access technologies, the control message determined based on the reported determined value representative of the energy consumption.

14. The apparatus of claim 11, wherein the determining further comprises:
determining the energy consumption during the transmission of one or more bits transmitted by the user equipment.

15. An apparatus comprising:
at least one processor; and
a memory configured to provide operations comprising:
sending a request for a value representative of an energy consumption of at least one of a transmission and a reception at a user equipment; and
receiving, in response to the request, the value representative the energy consumption for one of a plurality of radio access technologies available at the user equipment.

16. The apparatus of claim 15, wherein the value represents the energy consumption associated with at least one of the transmission and the reception of one or more bits using at least one of the plurality of radio access technologies.

17. The apparatus of claim 15, wherein the value represents the energy consumption associated with at least one of an idle mode and a connected mode of at least one of the plurality of radio access technologies.

18. A system comprising:
a network element; and
a user equipment, wherein the network element sends a request for an indication of a value representative of an energy consumption, wherein the user equipment
receives the request,
determines the value representative of the energy consumption during at least one of a transmission and a reception, and
reports the determined value to the network element.

19. A computer-readable medium including program code, which when executed by a processor, provides operations comprising:
receiving a request for an indication of a value representative of an energy consumption of at least one of a transmission and a reception at a user equipment;
determining, in response to the request, the value representative of the energy consumption, the value determined for one of a plurality of radio access technologies provided by the user equipment; and
reporting the determined value to a network element.

20. A computer-readable medium including program code, which when executed by a processor, provides operations comprising:
sending a request for a value representative of an energy consumption of at least one of a transmission and a reception at a user equipment; and
receiving, in response to the request, the value representative the energy consumption for one of a plurality of radio access technologies available at the user equipment.
